(19) United States
(12) Patent Application Publication
(10) Pub. No.: US 2022/0147834 A1
(43) Pub. Date: May 12, 2022

(54) COMPUTER-READABLE RECORDING MEDIUM STORING INFORMATION PROCESSING PROGRAM, APPARATUS, AND METHOD

(71) Applicant: FUJITSU LIMITED, Kawasaki-shi (JP)

(72) Inventors: KEN KOBAYASHI, Setagaya (JP); YUHEI UMEDA, Kawasaki (JP)

(73) Assignee: FUJITSU LIMITED, Kawasaki-shi (JP)

(21) Appl. No.: 17/464,831

(22) Filed: Sep. 2, 2021

(30) Foreign Application Priority Data
Nov. 12, 2020 (JP) 2020-188746

(51) Int. Cl. G06N 3/12; G06F 17/15; G06F 17/11

(52) U.S. Cl. CPC G06N 3/126; G06F 17/11; G06F 17/153

(57) ABSTRACT

A non-transitory computer-readable recording medium storing an information processing program for causing a computer to execute processing including: acquiring a plurality of points on a Pareto front of a multi-objective optimization problem; fitting a Bezier simplex defined using a plurality of control points to the plurality of points on the Pareto front; and determining whether the Pareto front is degenerated based on a positional relationship among the plurality of control points in the Bezier simplex after the fitting.

### CROSS-REFERENCE TO RELATED APPLICATION

This application is based upon and claims the benefit of priority of the prior Japanese Patent Application No. 2020-188746, filed on Nov. 12, 2020, the entire contents of which are incorporated herein by reference.

### FIELD

The technology discussed herein is related to an information processing program, an information processing apparatus, and an information processing method.

### BACKGROUND

In a multi-objective optimization problem that optimizes a plurality of objective functions at the same time, one optimal solution is not determined when a plurality of objective functions in a tradeoff relationship is optimized. Therefore, in the multi-objective optimization problem, the goal is to obtain a Pareto front, which is a curve or curved surface obtained when a plurality of solutions is plotted in an objective function space.

Furthermore, an algorithm of the multi-objective optimization problem has a problem that the calculation efficiency deteriorates due to an influence of the curse of dimensionality as the number of objective functions increases. Therefore, calculation of the multi-objective optimization problem can be made more efficient by specifying a redundant objective function from objective functions and removing the redundant objective function. Whether the plurality of objective functions of the multi-objective optimization problem includes the redundant objective function can be determined by finding a structure in which the Pareto front is degenerated, that is, the dimension of the Pareto front is reduced.

Furthermore, since the dimension of the Pareto front of the multi-objective optimization problem increases as the number of objective functions increases, a huge number of data is needed to cover the solution set constituting the Pareto front. Therefore, a technique of fitting a Bezier simplex model to the Pareto front to obtain an approximation of a high-dimensional solution set from a small amount of data has been proposed.

An example of the related art includes as follows: Ken Kobayashi, Naoki Hamada, Akiyoshi Sannai, Akinori Tanaka, Kenichi Bannai, and Masashi Sugiyama, “Bezier Simplex Fitting: Describing Pareto Fronts of Simplical Problems with Small Samples in Multi-Objective Optimization”, The Thirty-Third AAAI Conference on Artificial Intelligence (AAAI-19), 2019-07-17.

It is conceivable to visualize a scatter plot of points on the Pareto front and find the structure in which the Pareto front is degenerated from the arrangement of the points. However, in a case where the number of data is small and a solution set is sparse, it is difficult to find the structure in which the Pareto front is degenerated from the visualized scatter plot. Furthermore, the prior art of fitting the Bezier simplex model to the Pareto front does not mention the degeneration of the Pareto front.

As an aspect of the embodiments disclosed below, there is provided a solution to determine the presence or absence of degeneration of a Pareto front in a multi-objective optimization problem.

### SUMMARY

According to an aspect of the embodiments, in a non-transitory computer-readable recording medium storing an information processing program for causing a computer to execute processing, the processing includes: acquiring a plurality of points on a Pareto front of a multi-objective optimization problem; fitting a Bezier simplex defined using a plurality of control points to the plurality of points on the Pareto front; and determining whether the Pareto front is degenerated based on a positional relationship among the plurality of control points in the Bezier simplex after the fitting.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing degeneration of a Pareto front;

FIG. 2 is a diagram for describing a problem of visualization of the Pareto front;

FIG. 3 is a functional block diagram of an information processing apparatus;

FIG. 4 is a diagram illustrating an example of points on the Pareto front;

FIG. 5 is a diagram illustrating an example of a Bezier simplex;

FIG. 6 is a diagram for describing fitting of a Bezier simplex to the Pareto front;

FIG. 7 is a diagram for describing degeneration of the Bezier simplex;

FIG. 8 is a diagram illustrating an example of a result of fitting the Bezier simplex;

FIG. 9 is a diagram for describing a visualized image in a case of including four or more objective functions;

FIG. 10 is a block diagram illustrating a schematic configuration of a computer that functions as the information processing apparatus; and

FIG. 11 is a flowchart illustrating an example of an information processing routine.

### DESCRIPTION OF EMBODIMENTS

Hereinafter, an example of an embodiment according to the disclosed technology will be described with reference to the drawings.

First, degeneration of a Pareto front and a redundant objective function in a multi-objective optimization problem will be described before describing details of the embodiment.

The redundant objective function is an objective function that is improved at the same time as an improvement of a certain objective function, that is, an objective function that is not in a tradeoff relationship. For example, consider an objective function for minimizing weight and an objective function for minimizing volume in design of airplane wings. In this case, since the volume is minimized (improved) as the weight is minimized, it is sufficient to minimize only one of the objective functions and it can be said that the other objective function is redundant.

Meanwhile, consider an objective function for maximizing lift and an objective function for minimizing air resistance in design of airplane wings. In this case, to maximize the lift, the wings need to be made large and the air resistance becomes large (deteriorated). Therefore, these two objective functions are not redundant.

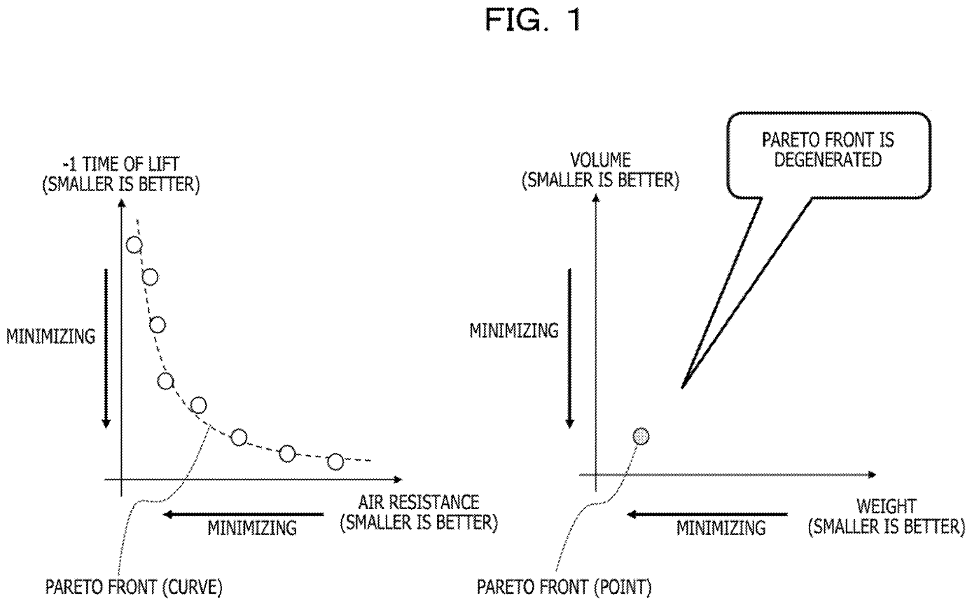

Whether the multi-objective optimization problem includes a redundant objective function according to whether the Pareto front is degenerated in consideration of the above relationship. Specifically, as illustrated in the left figure of FIG. 1, in the case where there is a tradeoff relationship between the two objective functions, the Pareto front becomes a curve. Meanwhile, as illustrated in the right figure of FIG. 1, in the case where there is no tradeoff relationship between the two objective functions, that is, the Pareto front between the redundant objective functions becomes a point. In this way, a structure (the point=zero dimension in the example of FIG. 1) in which the number of dimensions is lower than the original number of dimensions of the Pareto front in the case of not Including no redundant objective function (the curve=one dimension in the example of FIG. 1) is found as the structure in which the Pareto front is degenerated. Then, any one of the objective functions corresponding to the Pareto front having the degenerated structure can be specified as a redundant objective function.

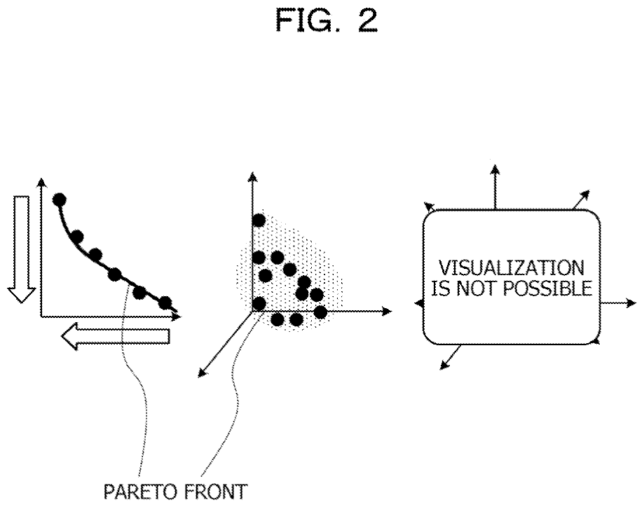

As described above, in the case where the number of data for obtaining a solution set is small and the solution set is sparse, it is difficult to find the structure in which the Pareto front is degenerated. Furthermore, as illustrated in FIG. 2, in the case of two objective functions, the Pareto front is one-dimensional (curve), in the case of three objective functions, the Pareto front is two-dimensional (curved surface), and in the case of four or more objective functions, the Pareto front is a three or more dimensional polyhedron. Therefore, even in the case of applying the prior art of fitting the Bezier simplex model to the Pareto front, it is difficult to find the structure in which the Pareto front is degenerated because the Pareto front is not able to be visualized. In the present embodiment, even in such a case, the structure in which the Pareto front is degenerated is found, and a redundant objective function is specified.

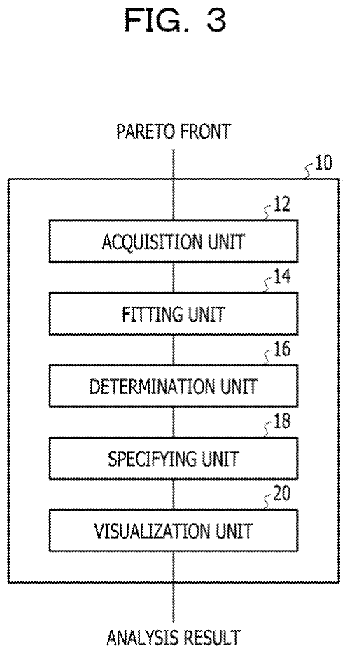

Functionally, an information processing apparatus 10 includes, as illustrated in FIG. 3, an acquisition unit 12, a fitting unit 14, a determination unit 16, a specifying unit 18, and a visualization unit 20.

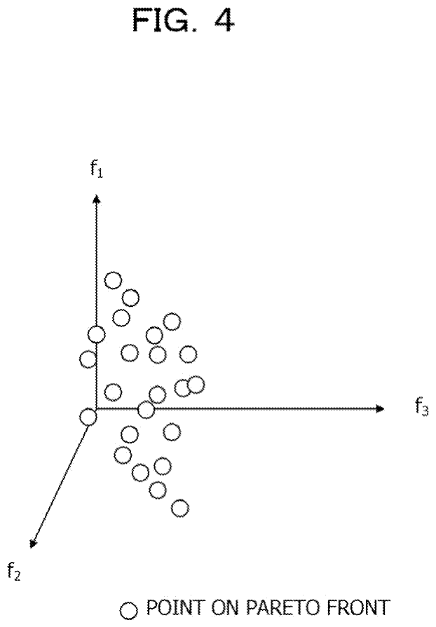

The acquisition unit 12 acquires coordinate values (hereinafter also simply referred to as “Pareto front”) of a plurality of points on the Pareto front for the multi-objective optimization problem to be analyzed, which are input to the information processing apparatus 10. The Pareto front is obtained by applying a multi-objective optimization algorithm such as a genetic algorithm, for example. FIG. 4 illustrates an example of points (white circles in FIG. 4) on the Pareto front of the multi-objective optimization problem that includes three objective functions (f₁, f₂, and f₆).

Here, the Pareto front that appears in reality is often simplex. Specifically, the Pareto front can be represented as a simplex of “the number of objective functions−1”-dimensional triangle. In this case, a solution to a problem of optimizing some objective functions constitutes vertices, sides, faces, or the like of the triangle.

Therefore, the fitting unit 14 fits the Bezier simplex to the plurality of points on the Pareto front acquired by the acquisition unit 12 (here, the Bezier simplex means a Bezier curve high-dimensionally generalized). By using the Bezier simplex, it is possible to fit the Bezier simplex to the Pareto front in consideration of a boundary of the solution corresponding to the vertices, sides, faces, or the like of the above-described triangle. Specifically, the fitting unit 14 uses an (M−1)-dimensional Bezier simplex of an order D defined by the following equation (1) (see Ken Kobayashi, Naoki Hamada, Akiyoshi Sannai, Akinori Tanaka, Kenichi Bannai, and Masashi Sugiyama, “Bezier Simplex Fitting: Describing Pareto Fronts of Simplicial Problems with Small Samples in Multi-Objective Optimization”, The Thirty-Third AAAI Conference on Artificial Intelligence AAAI-19), 2019-07-17.

$$b ( t ) \text{:=} {\sum }_{d ∈ {N}_{D}^{M}} ( \begin{matrix}D \\ d\end{matrix} ) {t}^{d} {p}_{d} ( t ∈ {Δ}^{M - 1} ) \qquad ( 1 )$$

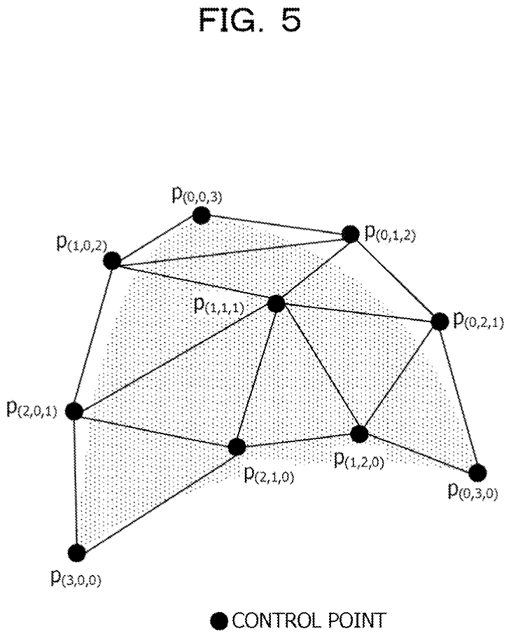

In the equation (1), t represents a parameter of the M-dimensional real vector, (D d) is a multinomial coefficient, t^{d} is a D-order monomial (multi-Index), p_{d} is a control point of the M-dimensional real vector, and Δ^{M-1} is an (M−1)-dimensional simplex. The number of the control points of the Bezier simplex is determined by the order D and the dimension M. FIG. 5 illustrates the Bezier simplex with D=3 and M=3. The subscripts of each control point p_{(i,j,k)} (the black circle in FIG. 5) are integers of 0 or more and satisfy i+j+k=D=3. In particular, p_{(3, 0, 0)}, p_{(0, 3, 0)}, and p_{(0, 0, 3)} are the control points corresponding to the vertices of the triangle indicating the Bezier simplex.

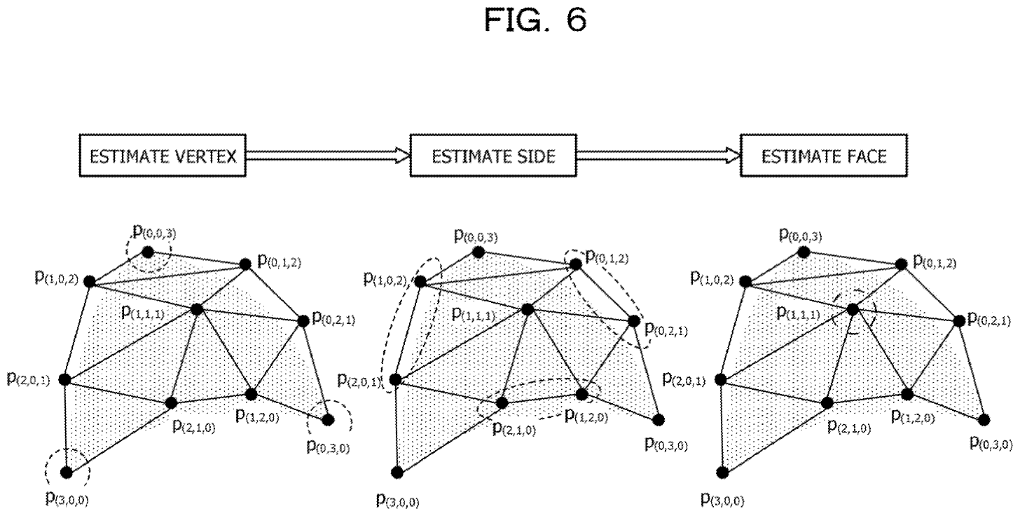

The fitting unit 14 estimates coordinates (vector values) indicating each control point by, for example, an inductive skeleton estimation method. The inductive skeleton estimation method is a method of estimating the control points that define a low-dimensional simplex (skeleton) in sequence, and the number of control points to be adjusted at one time does not depend on the number of objective functions. Therefore, it is possible to suppress the number of control points to be adjusted at one time even in approximation of a high-dimensional simplex. Specifically, the fitting unit 14 first estimates p_{(3, 0, 0)} as the first objective function, p_{(0, 3, 0)} as the second objective function, and p_{(0, 0, 3)} as the third objective function to match optimized solutions (the broken line portions in FIG. 6), as illustrated in “ESTIMATE VERTEX” in FIG. 6. Next, the fitting unit 14 estimates control points (the dotted line portions in FIG. 6) for determining the shape of the sides of the triangle in the state where the control points p_{(3, 0, 0)}, p_{(0, 3, 0)}, and p_{(0, 0, 3)} indicating the vertices of the triangle are fixed, as illustrated in “ESTIMATE SIDE” in FIG. 6. Then, the fitting unit 14 estimates control points (the one-dot dashed line portion in FIG. 6) for determining the shape of the faces of the triangle in the state where the control points corresponding to the vertices and the sides of the triangle are fixed, as illustrated in “ESTIMATE FACE” in FIG. 6.

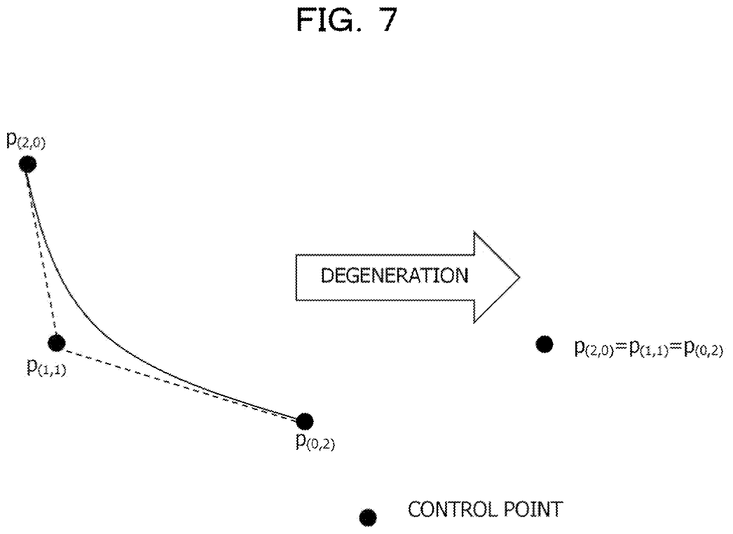

As described above, the Pareto front is degenerated in the case where a redundant objective function is included. Discuss this fact with the Bezier simplex fitted to the points on the Pareto front. Here, for the sake of simplicity, the Bezier simplex fitted to a two-dimensional Pareto front will be described. As illustrated in the left figure of FIG. 7, the Bezier simplex becomes a curve in the case where the Pareto front is not degenerated. On the other hand, in the case where the Pareto front is degenerated, all the control points of the Bezier simplex have the same coordinates and become points, as illustrated in the right figure of FIG. 7.

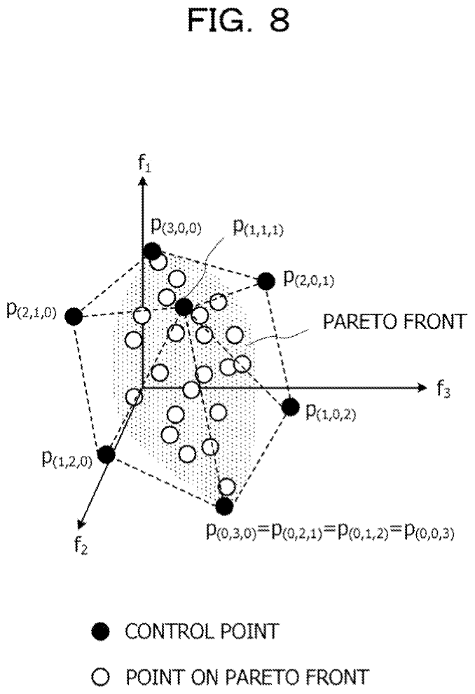

Therefore, the determination unit 16 determines whether the Pareto front is degenerated on the basis of the presence or absence of overlapping control points in the Bezier simplex after fitting by the fitting unit 14. The determination unit 16 determines that the control points in which the distance between the control points is equal to or less than a threshold value as the overlapping control points. Specifically, the determination unit 16 calculates the distance between the control points for combinations of all the control points, and determines whether the distance is equal to or less than a threshold value δ (δ>0). FIG. 8 illustrates an example of a result of fitting the Bezier simplex to the points on the Pareto front illustrated in FIG. 4. For example, in the case of ∥p_{(0, 3, 0)}−p_{(0, 2, 1)}∥=0<δ, the determination unit 16 determines that p_{(0, 3, 0)} and p_{(0, 2, 1)} overlap with each other. FIG. 8 illustrates an example in which the control points p_{(0, 3, 0)}, p_{(0, 2, 1)}, p_{(0, 1, 2)}, and p_{(0, 0, 3)} are determined to overlap with one another as a result of comparing the distance between the control points and the threshold value δ for the combinations of all the control points. The area between each two of p_{(0, 3, 0)}, p_{(0, 2, 1)}, p_{(0, 1, 2)}, and p_{(0, 0, 3)} is supposed to be a side of the triangle, but the coordinates of the control points match and become a point. The determination unit 16 determines that the Pareto front is degenerated in the case where the overlapping control points are present.

In the case where the determination unit 16 determines that the Pareto front is degenerated, that is, in the case where overlapping control points are present, the specifying unit 18 specifies a redundant objective function in the multi-objective optimization problem on the basis of the overlapping control points. For example, in the case where the control point representing the optimized solution for the first objective function included in the multi-objective optimization problem and the control point representing the optimized solution for the second objective function overlap, the specifying unit 18 specifies the first objective function or the second objective function as the redundant objective function. In the example of FIG. 8, p_{(0, 3, 0)} representing the optimized solution for the second objective function and p_{(0, 0, 3)} representing the optimized solution for the third objective function overlap. Therefore, the specifying unit 18 determines that the solutions that minimize the objective functions f₂ and f₃ match, and specifies f₂ or f₃ as the redundant objective function.

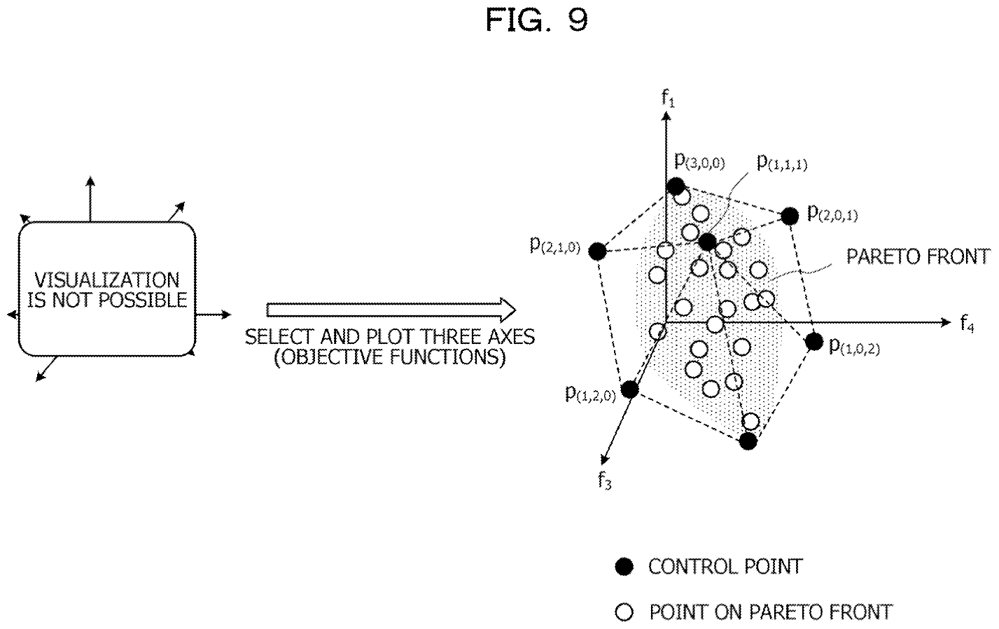

The visualization unit 20 generates an image (for example, FIG. 8, hereinafter referred to as “visualized image”) that visualizes the objective function space in which the Bezier simplex is fitted to the points on the Pareto front. As described above, the Pareto front is unable to be visualized in the case of including four or more objective functions. In this case, the visualization unit 20 generates a visualized image in which the Bezier simplex fitted to the plurality of points on the Pareto front is plotted in a two-dimensional space or a three-dimensional space corresponding to two or three objective functions selected from the four or more objective functions. For example, as illustrated in FIG. 9, in the case of receiving selection of three objective functions from the four or more objective functions, the visualization unit 20 generates the visualized image in which the Bezier simplex is plotted in the three-dimensional objective function space having the three objective functions as axes.

The visualization unit 20 outputs a determination result of whether the Pareto front is degenerated by the determination unit 16, a specification result of the redundant objective function by the specifying unit 18, and an analysis result including the generated visualized image. By outputting the visualized image as well, for example, the structure in which the Pareto front is degenerated can be visually checked.

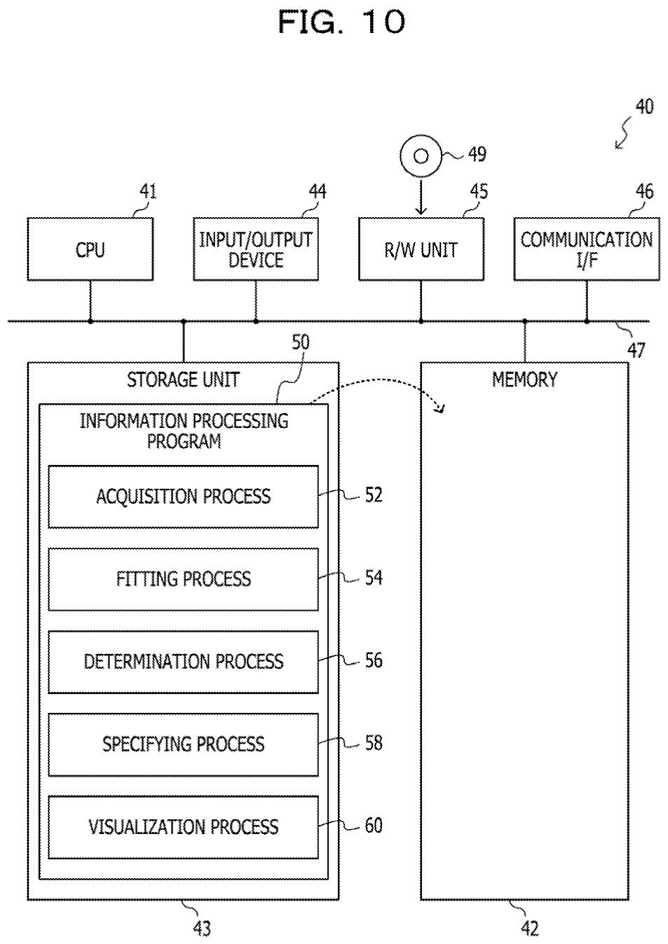

The information processing apparatus 10 can be implemented by a computer 40 illustrated in FIG. 10, for example. The computer 40 includes a central processing unit (CPU) 41, a memory 42 as a temporary storage region, and a nonvolatile storage unit 43. Furthermore, the computer 40 also includes an input/output device 44 such as an input unit or a display unit, a read/write (R/W) unit 45 that controls reading and writing of data to and from a storage medium 49. Furthermore, the computer 40 is provided with a communication interface (I/F) 46 connected to a network such as the Internet. The CPU 41, the memory 42, the storage unit 43, the input/output device 44, the R/W unit 45, and the communication I/F 46 are connected to each other via a bus 47.

The storage unit 43 can be implemented by a hard disk drive (HDD), a solid state drive (SSD), a flash memory, or the like. The storage unit 43 as a storage medium stores an information processing program 50 for causing the computer 40 to function as the information processing apparatus 10. The information processing program 50 includes an acquisition process 52, a fitting process 54, a determination process 56, a specifying process 58, and a visualization process 60.

The CPU 41 reads out the Information processing program 50 from the storage unit 43, expands the program into the memory 42, and sequentially executes the processes included in the information processing program 50. The CPU 41 executes the acquisition process 52 to work as the acquisition unit 12 illustrated in FIG. 3. Furthermore, the CPU 41 operates as the fitting unit 14 illustrated in FIG. 3 by executing the fitting process 54. Furthermore, the CPU 41 executes the determination process 56 to operate as the determination unit 16 illustrated in FIG. 3. Furthermore, the CPU 41 operates as the specifying unit 18 illustrated in FIG. 3 by executing the specifying process 58. Furthermore, the CPU 41 executes the visualization process 60 to operate as the visualization unit 20 illustrated in FIG. 3. This enables the computer 40 that has executed the information processing program 50 to function as the information processing apparatus 10. Note that the CPU 41 that executes programs is hardware.

Note that, functions achieved by the information processing program 50 can also be achieved, for example, by a semiconductor integrated circuit, in more detail, an application specific integrated circuit (ASIC) or the like.

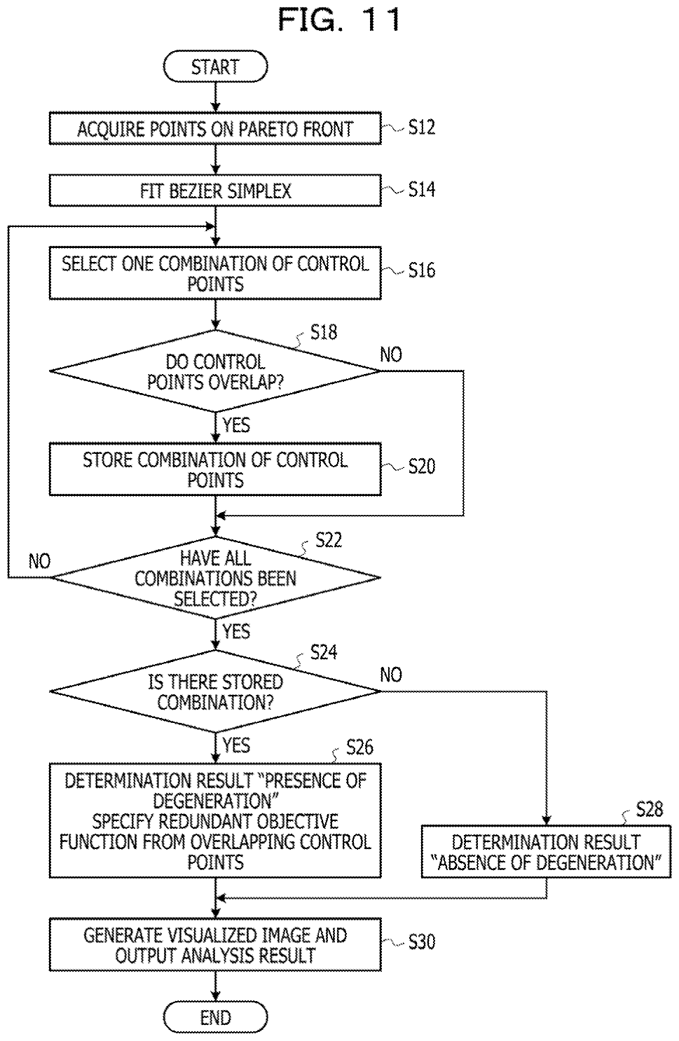

Next, operation of the information processing apparatus 10 according to the present embodiment will be described. When the Pareto front and the threshold value δ for the multi-objective optimization problem to be analyzed are input to the information processing apparatus 10, the information processing routine illustrated in FIG. 11 is executed in the information processing apparatus 10. Note that the information processing routine is an example of an information processing method of the disclosed technology.

In step S12, the acquisition unit 12 acquires the input coordinate values of a plurality of points on the Pareto front. Next, in step S14, the fitting unit 14 fits the Bezier simplex to the plurality of points on the Pareto front acquired by the acquisition unit 12.

Next, in step S16, the determination unit 16 selects one combination of two control points from the control points of the Bezier simplex after fitting by the fitting unit 14. Next, in step S18, the determination unit 16 calculates the distance between the selected control points and determines whether the control points overlap with each other by determining whether the distance is equal to or less than the threshold value δ. In the case where the control points overlap, the processing proceeds to step S20, information of the combination of overlapping control points is temporarily stored in a predetermined storage region, and the processing proceeds to step S22. In the case where the control points do not overlap, step S20 Is skipped and the processing proceeds to step S22.

In step S22, the determination unit 16 determines whether all the combinations of the control points included in the Bezier simplex have been selected. In the case where an unselected combination is present, the processing returns to step S16, and in the case where all the combinations have been selected, the processing proceeds to step S24.

In step S24, the determination unit 16 determines whether the information of the combination of control points stored in the predetermined storage region in step S20 described above is present. In the case where the information of the combination of control points is stored, the processing proceeds to step S26, and in the case where the information is not stored, the processing proceeds to step S28.

In step S26, the determination unit 16 generates the determination result indicating that the Pareto front is degenerated. Furthermore, the specifying unit 18 generates the specification result in which the objective function corresponding to the solution represented by one control point of the combination of overlapping control points is determined to be a redundant objective function. On the other hand, in step S28, the determination unit 16 generates the determination result indicating that the Pareto front is not degenerated, and the processing proceeds to step S30.

In step S30, the visualization unit 20 generates a visualized image that visualizes the objective function space in which the Bezier simplex is fitted to the points on the Pareto front. Then, the visualization unit 20 outputs an analysis result including the determination result and the specification result generated in step S26 described above, or the determination result generated in step S28 described above and the generated visualized image, and the information processing routine is terminated.

As described above, the information processing apparatus according to the present embodiment acquires a plurality of points on the Pareto front of the multi-objective optimization problem, and fits the Bezier simplex to the plurality of points on the Pareto front. Then, the information processing apparatus determines whether the Pareto front is degenerated on the basis of the presence or absence of overlapping control points in the Bezier simplex after fitting. Thereby, even in the multi-objective optimization problem containing four or more objective functions or in the case where the number of data is small and the solution set is sparse, the presence or absence of the Pareto front in the multi-objective optimization problem can be determined. Furthermore, the redundant objective function can be specified on the basis of which control points overlap. As a result, the redundant objective function can be removed to improve the calculation efficiency of the multi-objective optimization problem.

Note that, in the above-described embodiment, the case of outputting all of the determination result of the presence or absence of degeneration, the redundant objective function, and the visualized image has been described, but the present embodiment is not limited to the case. For example, the determination result of the presence or absence of degeneration and the visualized image may be output as the analysis result, the determination result of the presence or absence of degeneration and the redundant objective function may be output as the analysis result, or only the redundant objective function may be output as an analysis result.

Furthermore, while the above-described embodiment corresponds to a pattern in which the information processing program stored (installed) beforehand in the storage unit, provision of the program is not limited to this pattern. The program according to the disclosed technology can also be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
acquiring a plurality of points on a Pareto front of a multi-objective optimization problem;
fitting a Bezier simplex defined using a plurality of control points to the plurality of points on the Pareto front; and
determining whether the Pareto front is degenerated based on a positional relationship among the plurality of control points in the Bezier simplex after the fitting.

2. The non-transitory computer-readable recording medium storing an Information processing program according to claim 1, wherein
the processing of determining includes
determining whether the Pareto front is degenerated based on presence or absence of overlapping control points in the Bezier simplex after the fitting, and
determining the control points in which a distance between the control points is equal to or less than a threshold value as the overlapping control points.

3. The non-transitory computer-readable recording medium storing an information processing program according to claim 2, for causing the computer to execute processing further comprising: specifying a redundant objective function in the multi-objective optimization problem based on the overlapping control points in the case where the Pareto front is degenerated.

4. The non-transitory computer-readable recording medium storing an information processing program according to claim 3, wherein, in a case where a control point that represents an optimized solution for a first objective function included in the multi-objective optimization problem and a control point that represents an optimized solution for a second objective function overlap, the first objective function or the second objective function is specified as the redundant objective function.

5. The non-transitory computer-readable recording medium storing an information processing program according to claim 1, for causing the computer to execute processing further comprising: plotting the Bezier simplex fitted to the plurality of points on the Pareto front of the multi-objective optimization problem that includes four or more objective functions in a two-dimensional space that corresponds to two objective functions selected from the four or more objective functions or in a three-dimensional space that corresponds to three objective functions selected from the four or more objective functions to visualize the Bezier simplex.

6. The non-transitory computer-readable recording medium storing an information processing program according to claim 1, wherein the plurality of points on the Pareto front is obtained by applying a genetic algorithm to the multi-objective optimization problem.

7. An information processing apparatus comprising:
a memory; and
a processor coupled to the memory, the processor being configured to perform processing, the processing including:
acquiring a plurality of points on a Pareto front of a multi-objective optimization problem;
fitting a Bezier simplex defined using a plurality of control points to the plurality of points on the Pareto front; and
determining whether the Pareto front is degenerated based on a positional relationship among the plurality of control points in the Bezier simplex after the fitting.

8. A computer-implemented method comprising:
acquiring a plurality of points on a Pareto front of a multi-objective optimization problem;
fitting a Bezier simplex defined using a plurality of control points to the plurality of points on the Pareto front; and
determining whether the Pareto front is degenerated based on a positional relationship among the plurality of control points in the Bezier simplex after the fitting.
